(19) United States
(12) Patent Application Publication
(10) Pub. No.: US 2026/0147610 A1
(43) Pub. Date: May 28, 2026

(54) A Computer Software Module Scheduler, a Circuitry Scheduler, a Scheduler and a Method for Improved Scheduling

(71) Applicant: Telefonaktiebolaget LM Ericsson (publ), Stockholm (SE)

(72) Inventors: Bengt Wikenfalk, Domsten (SE); Patrik Åberg, Lund (SE)

(21) Appl. No.: 19/107,073

(22) PCT Filed: Sep. 5, 2022
(86) PCT No.: PCT/EP2022/074577

§ 371 Date: Feb. 27, 2025

(51) Int. Cl. G06F 9/48

(52) U.S. Cl. CPC G06F 9/4881; G06F 2209/485

(57) ABSTRACT

A method for scheduling a computational thread (240) to at least one processing resource (235) of a pool of processing resources (230) for execution in a combination of computational threads (250) comprising the computational thread and a plurality of other computational threads (245), the method being performed by a scheduler (210), the method comprising: determining if there is a stored record (225) representing a scheduling of the combination of computational threads (250) in a record store (220); if the stored record is of a recommended scheduling of the combination of computational threads (250), then perform the scheduling by selecting the recommended scheduling, and if the stored record is of a scheduling to be avoided, then avoid that scheduling, and if else use a default scheduling.

### TECHNICAL FIELD

The present invention relates to a scheduler, a scheduler comprising computer software modules, an scheduler comprising circuits, and a method for providing an improved manner of scheduling tasks, and in particular to a scheduler, a scheduler comprising computer software modules, an scheduler comprising circuits, and a method for providing an improved manner of scheduling of tasks in a multi-core system where processors are sharing memory.

### BACKGROUND

As computer applications grow in complexity so does the requirement for processing power. As a result, more and more computing devices or processing systems are relying on multiple cores (or processors) sharing memory resources to allow for multithreading and multiprocessing. Multithreading is the ability of a central processing unit (CPU) (or a single core in a multi-core processor) to provide multiple threads of execution concurrently, supported by the operating system. In a multithreaded application, the threads share the resources of a single or multiple cores, which include the computing units, the processor caches, and the translation lookaside buffer (TLB). Multiprocessing systems include multiple complete processing units in one or more cores. As the two techniques are complementary, they are combined in nearly all modern systems architectures with multiple multithreading CPUs and with CPUs with multiple multithreading cores. Multithreading and multiprocessing systems will hereafter be referred to as multi-core systems.

It is common to have a scheduler in such multi-core systems where scheduling is the action of assigning processing resources to perform tasks. The resources may be processors, memories, network links or expansion cards. The tasks may be threads, processes or data flows. A thread of execution is the smallest sequence of programmed instructions that can be managed independently by a scheduler, which is typically a part of the operating system. The implementation of threads and processes differs between operating systems, but in most cases a thread is a component of a process. Schedulers are often designed so as to keep all computer resources busy (as in load balancing), allow multiple users to share system resources effectively, or to achieve a target quality-of-service. Scheduling is fundamental to computation itself, and an intrinsic part of the execution model of a computer system.

When assigning or scheduling a thread to resources, there are several factors that can influence the execution of the thread. These factors include what other threads are executed at the same time. And, as the number of combinations of threads that can execute at the same time rows exponentially with the number of threads, it becomes very time consuming to try to determine a preferable resource allocation for a given combination. At the same time, the scheduling is highly time-sensitive, especially as the time to execute a thread is usually in itself time-sensitive.

Various techniques have been proposed for multi-core systems, where-in order to ensure that a service has access to sufficient processing resources-several monitoring systems are proposed. The monitoring systems monitor the performance of one or more services and based on the performance provides the required processing resources. These systems all require detailed data for various combinations. Estimates indicates that the required size of this data soon reaches a GigaByte (GB) size requirement. Handling and searching in memory areas that big, is not feasible for scheduling decisions. Normal data-reduction techniques are also not applicable to such data stores, as such techniques are either too expensive (performance-wise) or do not fulfill other requirements.

There is thus a need for a more efficient manner of both providing scheduling of multi-core systems in a time-efficient manner.

### SUMMARY

The inventors have realized that reductions to the huge data-volumes are required for keeping all scheduling information. The inventors have also realized that some (if not most) scheduling decisions (or deployments) for thread combinations will not differ very much from what would be the case using a random algorithm. This has lead the inventors—after inventive reasoning—to the inventive insight that such thread combinations are not necessary to track and can be discarded.

As will be shown below, this has provided an extremely simple and elegant manner for providing scheduling of multiple threads in multi-core systems.

According to one aspect there is provided a method for scheduling a computational thread to at least one processing resource of a pool of processing resources for execution in a combination of computational threads comprising the computational thread and a plurality of other computational threads, the method being performed by a scheduler, the method comprising: determining if there is a stored record representing a scheduling of the combination of computational threads in a record store; if the stored record is of a recommended scheduling of the combination of computational threads, then perform the scheduling by selecting the recommended scheduling, and if the stored record is of a scheduling to be avoided, then avoid that scheduling while using a default scheduling, and if else use the default scheduling.

According to one aspect a method is provided for scheduling a computational thread to at least one processing resource of a pool of processing resources for execution in a combination of computational threads comprising the computational thread and a plurality of other computational threads, the method being performed by a scheduler, the method comprising: determining if there is a stored record representing a scheduling of the combination of computational threads in a record store; if there is a stored record, determine if the represented scheduling of the combination of computational threads is a recommended scheduling of the combination of computational threads; and if the represented scheduling of the combination of computational threads is a recommended scheduling of the combination of computational threads, then perform the scheduling by selecting the recommended scheduling of the combination of computational threads thereby providing a selected scheduling of the combination of computational threads, and if the represented scheduling of the combination of computational threads is not a recommended scheduling of the combination of computational threads, then perform the scheduling based on the default scheduling algorithm avoiding the represented scheduling of the combination of computational threads thereby providing the selected scheduling of the combination of computational threads different from the represented scheduling of the combination of computational threads, wherein each record in the plurality of stored records represents a scheduling of a combination of computational threads and a computational value for the combination of computational threads, wherein the computational value for the combination of computational threads is either above a recommended threshold, whereby the record is a recommended record, or below an avoidance threshold, whereby the record is a record to be avoided.

The solution may be implemented as a software solution, a hardware solution or a mix of software and hardware components.

In some embodiments the method further comprises if there is no stored record, performing the scheduling based on a default scheduling algorithm providing the selected scheduling of the combination of computational threads.

In some embodiments the recommended scheduling indicates the at least one processing resource to be used for scheduling.

In some embodiments the recommended scheduling is the represented scheduling with the highest computational value (fastest execution time)

In some embodiments the method further comprises marking the represented scheduling with the highest computational value as unavailable during the execution of the scheduled computational thread, whereby the represented scheduling with the second highest computational value is regarded as the represented scheduling with the highest computational value.

In some embodiments the recommended threshold is determined based on a distance to the average of computational values and is greater than the average of computational values, and wherein the avoiding threshold is determined based on a distance to the average of computational values and is lower than the average of computational values.

In some embodiments the method further comprises updating the record store by: determining a computational value for the selected scheduling; determining if the computational value for the selected scheduling is above the recommended threshold or below the avoidance threshold, and if so storing a record for the selected scheduling.

In some embodiments the storing of a record for the selected scheduling comprises determining if there is a stored record for the selected scheduling and if so, updating the stored record with the determined computational value.

In some embodiments the updating of the record store further comprises determining if the record store is full prior to determining if the computational value for the selected scheduling is above the recommended threshold or below the avoidance threshold, and if the record store is not full, storing the record for the selected scheduling.

In some embodiments the method further comprises determining an average of computational values prior to determining if the computational value for the selected scheduling is above the recommended threshold or below the avoidance threshold.

In some embodiments the updating the record store further comprises increasing the age of the records in the record store, wherein the age of avoided record(s) and selected record(s) are not increased.

In some embodiments the age of avoided record(s) and selected record(s) are not increased by setting the age of the record to 0 (zero).

According to one aspect is provided a record store comprising a plurality of records, each record in the plurality of stored records indicates a combination of computational threads and a computational value for the combination of computational threads, wherein the computational value for the combination of computational threads is either above a recommended threshold, whereby the record is a recommended record, or below an avoidance threshold, whereby the record is a record to be avoided, wherein the record store is configured to update the record store by: determining a computational value for a selected scheduling; determining if the computational value for the selected scheduling is above the recommended threshold or below the avoidance threshold, and if so storing a record for the selected scheduling.

In some embodiments, the record store is further configured to update the record store by deleting records whose age is below an age threshold.

According to one aspect is provided a computing arrangement configured to schedule a computational thread to at least one processing resource of a pool of processing resources for execution in a combination of computational threads comprising the computational thread and a plurality of other computational threads, the method being performed by a scheduler, the scheduler being configured to: determine if there is a stored record representing a scheduling of the combination of computational threads in a record store; if there is a stored record, determine if the represented scheduling is a recommended scheduling; and if the represented scheduling is a recommended scheduling, then perform the scheduling by selecting the recommended scheduling, and if the represented scheduling is not a recommended scheduling, then perform the scheduling based on the default scheduling algorithm avoiding the represented scheduling providing a selected scheduling different from the represented scheduling, wherein each record in the plurality of stored records indicates a represented scheduling of a combination of computational threads and a computational value for the combination of computational threads, wherein the computational value for the combination of computational threads is either above a recommended threshold, whereby the record is a recommended record, or below an avoidance threshold, whereby the record is a record to be avoided.

According to one aspect is provided a computer-readable medium carrying computer instructions that when loaded into and executed by a controller of a computing arrangement enables the computing arrangement to implement the method according to herein.

According to one aspect is provided a software component scheduler for scheduling a computational thread to at least one processing resource of a pool of processing resources for execution in a combination of computational threads comprising the computational thread and a plurality of other computational threads, wherein the software component scheduler comprises: a software component for determining if there is a stored record representing a scheduling of the combination of computational threads in a record store; a software component for determining if the represented scheduling of the combination of computational threads is a recommended scheduling of the combination of computational threads if there is a stored record; and a software component for performing the scheduling by selecting the recommended scheduling of the combination of computational threads thereby providing a selected scheduling of the combination of computational threads if the represented scheduling of the combination of computational threads is a recommended scheduling of the combination of computational threads, a software component for perform the scheduling based on the default scheduling algorithm avoiding the represented scheduling of the combination of computational threads thereby providing the selected scheduling of the combination of computational threads different from the represented scheduling of the combination of computational threads if the represented scheduling of the combination of computational threads is not a recommended scheduling of the combination of computational threads, wherein each record in the plurality of stored records represents a scheduling of a combination of computational threads and a computational value for the combination of computational threads, wherein the computational value for the combination of computational threads is either above a recommended threshold, whereby the record is a recommended record, or below an avoidance threshold, whereby the record is a record to be avoided.

According to one aspect is provided a scheduler comprising circuitry for scheduling a computational thread to at least one processing resource of a pool of processing resources for execution in a combination of computational threads comprising the computational thread and a plurality of other computational threads, wherein the scheduler comprises: circuitry arranged to determine if there is a stored record representing a scheduling of the combination of computational threads in a record store; circuitry arranged to determine if the represented scheduling of the combination of computational threads is a recommended scheduling of the combination of computational threads if there is a stored record; and circuitry arranged to perform the scheduling by selecting the recommended scheduling of the combination of computational threads thereby providing a selected scheduling of the combination of computational threads if the represented scheduling of the combination of computational threads is a recommended scheduling of the combination of computational threads, circuitry arranged to perform the scheduling based on the default scheduling algorithm avoiding the represented scheduling of the combination of computational threads thereby providing the selected scheduling of the combination of computational threads different from the represented scheduling of the combination of computational threads if the represented scheduling of the combination of computational threads is not a recommended scheduling of the combination of computational threads, wherein each record in the plurality of stored records represents a scheduling of a combination of computational threads and a computational value for the combination of computational threads, wherein the computational value for the combination of computational threads is either above a recommended threshold, whereby the record is a recommended record, or below an avoidance threshold, whereby the record is a record to be avoided.

The teachings herein find use in any multi-core computer system that has a hierarchical cache system and where the execution elements (for examples CPUs) can be arranged into groups consisting of 1-N members.

Further embodiments and advantages of the present invention will be given in the detailed description. It should be noted that the teachings herein find use in schedulers in many areas of software monitoring of real-time service systems.

### BRIEF DESCRIPTION OF THE DRAWINGS

Embodiments of the invention will be described in the following, reference being made to the appended drawings which illustrate non-limiting examples of how the inventive concept can be reduced into practice.

FIG. 1A shows a schematic view of a computing arrangement configured to execute a scheduler according to an embodiment of the teachings herein;

FIG. 1B shows a schematic view of a computing arrangement configured to execute a scheduler according to an embodiment of the teachings herein;

FIG. 1C shows a schematic view of a computing arrangement configured to execute a scheduler according to an embodiment of the teachings herein;

FIG. 2 shows a schematic view of a scheduler according to one embodiment of the teachings herein;

FIG. 3 shows a flowchart of a general method according to an embodiment of the present invention;

FIG. 4 shows a component view for a scheduler comprising software modules according to an embodiment of the teachings herein;

FIG. 5 shows a component view for an scheduler comprising circuits according to an embodiment of the teachings herein; and

FIG. 6 shows a schematic view of a computer-readable medium carrying computer instructions that when loaded into and executed by a controller of a scheduler enables the scheduler to implement an embodiment of the present invention.

### DETAILED DESCRIPTION

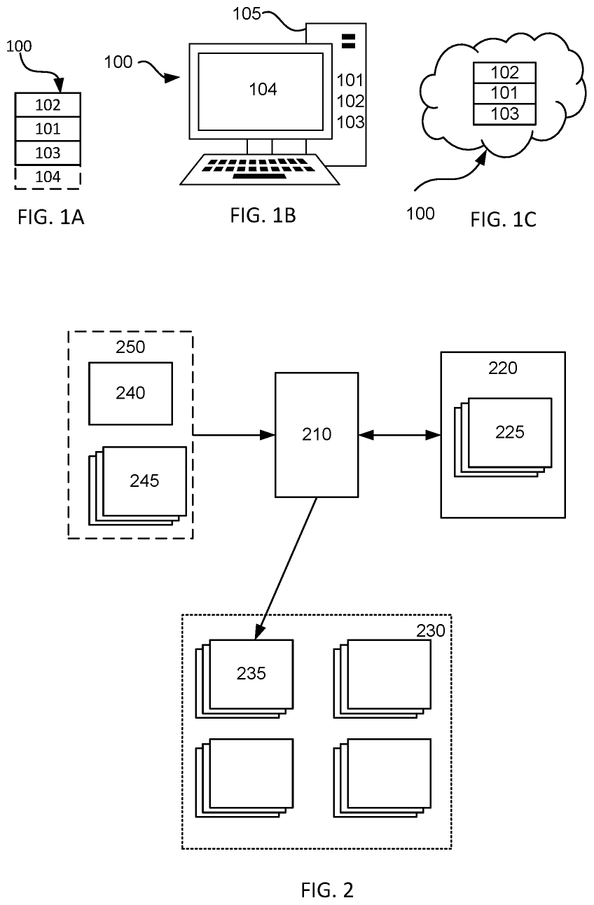

FIG. 1A shows a schematic view of a computing arrangement configured to execute a scheduler 100 according to an embodiment of the present invention. The computing arrangement 100 comprises a controller 101 and a memory 102. It should be noted that the computing arrangement 100 may comprise a single device, such as a server, or may be distributed across several devices and apparatuses. It should also be noted that the scheduler is, in some embodiments, designed to not only execute a scheduler module, but may also be designed to execute some or all of a multi-core system, and may in some such embodiments, be the whole multi-core system. In some such systems, the computing arrangement 100 is thus the multicore system and the scheduling of multiple threads is performed by the controller 101 executing a scheduler module as discussed with relation to FIG. 2.

The controller 101 is configured to control the overall operation of the computing arrangement 100. In one embodiment, the controller 101 is one or more general purpose processors. As a skilled person would understand there are many alternatives for how to implement a controller, such as using Field-Programmable Gate Arrays circuits, AISIC, GPU, etc. in addition or as an alternative. For the purpose of this application, all such possibilities and alternatives will be referred to simply as the controller 101.

The memory 102 is configured to store data and computer-readable instructions that when loaded into the controller 101 indicates how the computing arrangement 100 is to be controlled. The memory 102 may comprise one or several memory modules, partitions, allocations, units or devices, but they will be perceived as being part of the same overall memory 102. There may be one memory unit for storing data, one memory for the communications interface (see below) for storing settings, and so on. As a skilled person would understand there are many possibilities of how to select where data should be stored and a general memory 102 for the computing arrangement 100 is therefore seen to comprise any and all such memory units for the purpose of this application. As a skilled person would understand there are many alternatives of how to implement a memory, for example using non-volatile memory circuits, such as EEPROM memory circuits, or using volatile memory circuits, such as RAM memory circuits. The memory 102 may also be an allocation of a larger memory partition. For the purpose of this application all such alternatives will be referred to simply as the memory 102.

In one embodiment the computing arrangement 100 further comprises a communication interface 103. The communication interface may be wired and/or wireless. The communication interface may comprise several interfaces.

In one embodiment the communication interface comprises a USB (Universal Serial Bus) interface. In one embodiment the communication interface comprises an analog interface, a CAN (Controller Area Network) bus interface, an I2C (Inter-Integrated Circuit) interface, or other interface.

In one embodiment the communication interface comprises a radio frequency (RF) communications interface. In one such embodiment the communication interface comprises a Bluetooth™ interface, a WiFi™ interface, a ZigBee™ interface, a RFID™ (Radio Frequency IDentifier) interface, Wireless Display (WiDi) interface, Miracast interface, and/or other RF interface commonly used for short range RF communication. In an alternative or supplemental such embodiment the communication interface comprises a cellular communications interface such as a fifth generation (5G) cellular communication interface, an LTE (Long Term Evolution) interface, a GSM (Global Systéme Mobilé) interface and/or other interface commonly used for cellular communication. In one embodiment the communications interface is configured to communicate using the UPnP (Universal Plug n Play) protocol. In one embodiment the communications interface is configured to communicate using the DLNA (Digital Living Network Appliance) protocol.

In one embodiment, the communications interface 103 is configured to enable communication through more than one of the example technologies given above.

The communications interface 103 may be configured to enable the computing arrangement 100 to communicate with services that are part of the (real-time) services for receiving data on (real-time) performance from such (real-time) services. The communications interface 103 may be configured to enable the computing arrangement 100 to communicate with a multi-core system for communicating scheduling of processing resources. It should be noted that the scheduler may be part of or executed as part of the multi-core system

As is indicated in FIG. 1A, the computing arrangement 100 may in some embodiments comprise a user interface 104. FIG. 1B shows a schematic view of one such example of a computing arrangement 100 according to an embodiment of the present invention. The computing arrangement 100 in this example is a desktop computer or work station 100 comprising a housing 105 in which the controller 101, the memory 102 and the communication interface 103 is housed. The workstation is in this example provided with a user interface 104 comprising a display and a keyboard.

FIG. 1C shows a schematic view of another example of a computing arrangement 100 according to an embodiment of the present invention. The computing arrangement 100 in this example is part of a server or cloud service, wherein the controller 101, the memory 102 and the communication interface 103 is comprised in the server.

FIG. 2 shows a schematic view of components of a computing environment for a multicore system 200 to be executed on or performed by a computing arrangement 100 according to one embodiment of the teachings herein. It should be noted that the scheduler need not comprise all, some or any of the components shown in FIG. 2, but only needs to store, be aware of or have access to data regarding such components.

In some embodiments the environment comprises a pool of processing resources 230 and a plurality of computational threads 250, wherein a scheduler controller module 210 is configured to schedule a computational thread 240 to at least one processing resource 235 out of the pool of processing resources 230 for execution in a combination of computational threads 250 comprising the computational thread and a plurality of other computational threads.

It should be noted that since the scheduler 210 is executed by the controller 101 of the computing arrangement 100 and as there is made no difference between the two, there is also not made any difference between the scheduler 210 comprising some functionality or the controller 101 of the computing arrangement configured to execute a scheduler 100 being configured to execute such functionality.

The processing resources 235 may relate to allotted bandwidth, processor cores, processor execution time, memory space, memory access speed [MORE EXAMPLES?] and so on to mention a few examples.

The scheduler 210 is operatively connected to, such as being connected to or comprising, a record store 220. The record store may be implemented as a memory module, a memory area in a memory, a stand-alone memory or as an arrangement comprising a memory such as a computing arrangement as according to FIG. 1A, 1B or 1C. The record store comprises one or more plurality of stored records 225. Naturally upon initialization, the record store is empty and is filled up over time and the record store 220 may thus also be empty.

As discussed in the summary, the number of records increases with the number of thread-combinations, and the number of clusters, i.e groups of processing resources. As the inventors have realized, if all execution records are to be saved, this will require excessive memory, and lookups for records will consume too much time. The inventors are therefore proposing to reduce the number of required records, since records with associated costs close to the centre of gravity or average of costs for execution of a thread are very likely to have scheduling properties like any (random) scheduling approach. Instead, only records where the cost is removed from the centre of gravity are stored. In some such embodiments, the difference in cost compared to centre of gravity determines if the record is stored, where this determination depends on the memory size. Furthermore, the inventors have also realized that qualified, i.e. store, records may become stale (for example as a thread disappears from execution) or have very low repetition-rate. Buy keeping track of the usage (or rather non-usage), these records can be discarded from storage after some time to allow for more relevant records to be stored.

The scheduler therefore measures a desired property of a thread combination, i.e. the cost, such as time consumed or time consumed on resource(s), when a thread belonging to a combination terminates. The measured property of the execution updates an existing record or tries to qualify for insertion into the record store. If the qualification fails, the record is discarded. When a scheduling attempt (of a thread) happens, the records are scanned for any valid combination of the thread, and the best/worst valid combination is used to control the scheduling. And, to allow for keeping the record up to date, unused records'age is incremented. The age of the record for the combination of threads used by the last scheduling (either recommended or to be avoided) is not incremented. This allows for the record to remain fresh and avoids the need for any artificial timestamps as the increment in time (the “tick”) is driven by scheduler events and not by an artificial time-keeping.

After completion of a thread-combination execution, it will be determined if there is a record for the combination and if so, the record is updated with the statistics (such as the measured properties) of the execution. If there is no record, it will be determined if the execution qualifies for entering the record store. This qualification is based on the measured properties and how far removed these are from the centre-of-gravity of all executions. This determination need not be made during scheduling but can be determined after (or before a next) scheduling, thereby enabling the scheduling to be executed in a time-efficient manner.

The centre-gravity is determined and maintained at intervals or after each scheduling event, which enables for a lower memory requirement as only the centre of gravity (and possibly supporting data such as number of executions) need be stored over time, not each individual result.

After the scheduling (or before a next), it is determined if any record has become stale. This is done based on an age of the record, where records having an age exceeding a threshold level are discarded. The threshold level may be dynamic and change depending on how many records are stored and how many are to be included in the record store. In order to allow for a weighting or priority of records, the distance from the centre-of-gravity (the measure property) is also in some embodiments taken into account. This is achieved by reducing the age to be compared with the threshold for each record with a factor based on the value of the record. In some embodiments the factor is based on a goodness number for a previous run (such as a goodness of fit number), wherein the age is reduced by a factor k (k=0 . . . K, K=age/threshold) and the resulting age is ABS(goodness number−k*previous age). In the following the distance from the centre-of gravity and the measured properties, from which the distance may be derived, will be referred to as the value of the record including both possibilities.

As discussed in the above, used records should not be easily discarded, and the age of a used record will therefore not be increased when the ages of the records of the record store are increased. This can be done by noting which records were used and later only increasing the age of the records that were not used. Alternatively this can be done, by decreasing the age of the used record already at the scheduling event, whereby a later increase has less effect (if any). A decrease can in some embodiments be to set the age to zero (0).

By separating the house-keeping of the record store from the actual scheduling, the scheduling can be performed in a time-efficient manner. It should be noted that the measuring o executions, the house-keeping of records or other functions may be performed by separate modules, but will for the purpose of this application be considered to be executed by the scheduler. It should thus be appreciated that the actual scheduling, measuring (or monitoring) and the house-keeping may be performed by separate modules, perhaps even in separate computing arrangements.

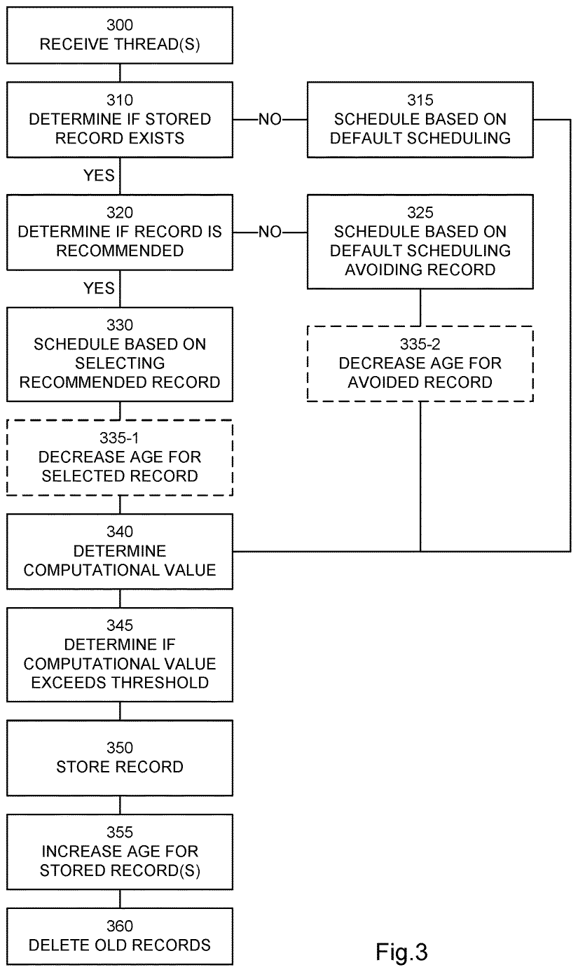

The operation of the scheduler 210 (possibly including the monitoring and the house-keeping as discussed above, which may be performed by separate modules) will be described with simultaneous reference to FIG. 3 and FIG. 2.

FIG. 3 shows a flowchart of a general method according to an embodiment of the teachings herein. The method is executed in a computing arrangement 100 and utilizes a scheduler 210 as disclosed with reference to FIG. 2. As already discussed, a combination of threads 250 indicating a thread 240 to be executed in combination with other threads 245 is received 300. It is determined 310 if there is a stored record 225 representing a scheduling of the combination of computational threads 250 in a record store 220. As discussed above, the record store (and possibly the housekeeping) may be part of a scheduling module or may be a separate scheduling module, but will be seen herein as part of the scheduler 210. The possibility of separate housekeeping of the record store and the actual scheduling is indicated in FIG. 2 by representing the record store 220 and the scheduler 210 as separate components.

If there is a stored record, it is determined 320 if the represented scheduling of the combination of computational threads 250 is a recommended scheduling of the combination of computational threads 250; and if the represented scheduling of the combination of computational threads 250 is a recommended scheduling of the combination of computational threads 250, then the scheduling is performed 330 by selecting the recommended scheduling of the combination of computational threads 250 thereby providing a selected scheduling of the combination of computational threads 250, and if the represented scheduling of the combination of computational threads 250 is not a recommended scheduling of the combination of computational threads 250, then the scheduling is performed 325 based on the default scheduling algorithm avoiding the represented scheduling of the combination of computational threads 250 thereby providing the selected scheduling of the combination of computational threads 250 different from the represented scheduling of the combination of computational threads 250.

As discussed in relation to FIG. 2. each record 225 in the plurality of stored records 220 represents a scheduling of a combination of computational threads and a computational value for the combination of computational threads, wherein the computational value for the combination of computational threads is either above a recommended threshold, whereby the record is a recommended record, or below an avoidance threshold, whereby the record is a record to be avoided. In some embodiments the recommended threshold is determined based on a distance to the average of computational values and is greater than the average of computational values, and wherein the avoiding threshold is determined based on a distance to the average of computational values and is lower than the average of computational values.

The computational value can be the distance to the centre-of-gravity or a value from which the distance can be derived. As the centre-of gravity changes, it is easier to simply use a measured execution property as the computational value.

In some embodiments the method further comprises—if there is no stored record performing 315 the scheduling based on a default scheduling algorithm providing the selected scheduling of the combination of computational threads 250.

If there is no stored record, the default scheduling algorithm is used. This will provide a measurement of a desired property for the computation and a new record may be generated as discussed above in relation to FIG. 2.

In some embodiments the recommended scheduling indicates the at least one processing resource 235 to be used for scheduling, whereby the scheduling will be simple and based on this at least one processing resource 235.

In some embodiments the recommended scheduling is the represented scheduling with the highest computational value, such as the fastest execution time. However, in some instances this scheduling may be occupied, wherein the recommended scheduling is the represented scheduling with the second highest computational value. In some such embodiments the method further comprises marking the represented scheduling with the highest computational value as unavailable during the execution of the scheduled computational thread, whereby the represented scheduling with the second highest computational value is regarded as the represented scheduling with the highest computational value.

In some embodiments, the method further comprises updating the record store by determining 340 a computational value for the selected scheduling and determining 345 if the computational value for the selected scheduling is above the recommended threshold or below the avoidance threshold, and if so storing 350 a record for the selected scheduling.

As discussed in the above, such house-keeping may be performed by the scheduler or by the record store (storage handler) 220. For the purpose of the teachings herein, the scheduler and the storage handler will be seen as comprised in a same module.

In some embodiments, the storing 350 of a record for the selected scheduling comprises determining if there is a stored record for the selected scheduling and if so, updating the stored record with the determined computational value. In some embodiments, the value is only updated if it has a higher computational value.

In some embodiments, the updating the record store further comprises determining if the record store is full prior to determining if the computational value for the selected scheduling is above the recommended threshold or below the avoidance threshold, and if the record store is not full, storing the record for the selected scheduling.

In some embodiments, the method further comprises determining an average of computational values prior to determining if the computational value for the selected scheduling is above the recommended threshold or below the avoidance threshold. This is done in order to not affect the centre-of-gravity (the average) by the new record.

In some embodiments, the updating of the record store further comprises increasing 355 the age of the records in the record store, wherein the age of avoided record(s) and selected record(s) are not increased. As discussed in the above, the age of the used records may be decreased 335 prior to this increase, or they may simply be exempt from the increase in age. In some such embodiments, the age of avoided record(s) and selected record(s) are not increased by setting the age of the record to 0 (zero).

The record store may then be updated by deleting 360 old records as discussed in the above.

As discussed in the above, the house-keeping may be performed by the record store 220, which—to summarize—comprises a plurality of records 225, each record in the plurality of stored records indicates a combination of computational threads and a computational value for the combination of computational threads, wherein the computational value for the combination of computational threads is either above a recommended threshold, whereby the record is a recommended record, or below an avoidance threshold, whereby the record is a record to be avoided, wherein the record store is configured to update the record store by: determining a computational value for a selected scheduling; and determining if the computational value for the selected scheduling is above the recommended threshold or below the avoidance threshold, and if so storing a record for the selected scheduling.

In some embodiments, the record store is further configured to update the record store by deleting records whose age is below an age threshold.

As discussed above, the age threshold may be determined based on the size or the available size of the memory for storing the record store.

As also discussed above, the computing arrangement of FIG. 1A, 1B or 1C may be utilized to implement a method as discussed herein.

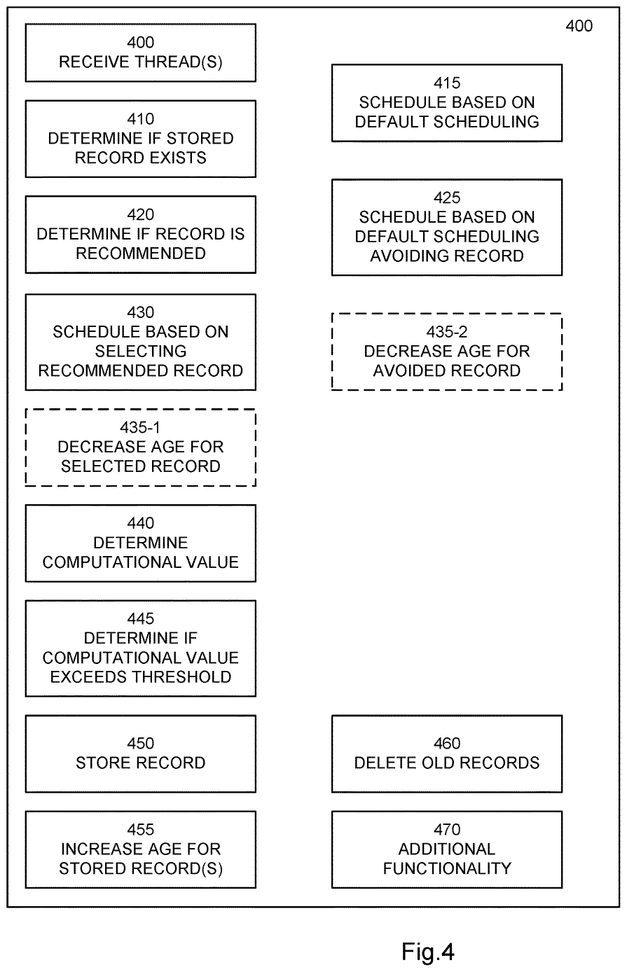

FIG. 4 shows a component view for a software component (or module) scheduler 400 according to an embodiment of the teachings herein. The software component scheduler 400 is adapted to be used in a computing arrangement 100 as taught herein for multiple threads in a multi-core system as taught herein, wherein the software component scheduler 400 is for scheduling a computational thread 240 to at least one processing resource 235 of a pool of processing resources 230 for execution in a combination of computational threads 250 comprising the computational thread and a plurality of other computational threads 245, wherein the software component scheduler 400 comprises: a software component 410 for determining if there is a stored record 225 representing a scheduling of the combination of computational threads 250 in a record store 220; a software component for determining 420 if the represented scheduling of the combination of computational threads 250 is a recommended scheduling of the combination of computational threads 250 if there is a stored record; and a software component for 425 performing the scheduling by selecting the recommended scheduling of the combination of computational threads 250 thereby providing a selected scheduling of the combination of computational threads 250 if the represented scheduling of the combination of computational threads 250 is a recommended scheduling of the combination of computational threads 250, a software component for 425 performing the scheduling based on the default scheduling algorithm avoiding the represented scheduling of the combination of computational threads 250 thereby providing the selected scheduling of the combination of computational threads 250 different from the represented scheduling of the combination of computational threads 250 if the represented scheduling of the combination of computational threads 250 is not a recommended scheduling of the combination of computational threads 250, wherein each record in the plurality of stored records represents a scheduling of a combination of computational threads and a computational value for the combination of computational threads, wherein the computational value for the combination of computational threads is either above a recommended threshold, whereby the record is a recommended record, or below an avoidance threshold, whereby the record is a record to be avoided.

As is indicated in FIG. 4, the software component scheduler 400 comprises, in some embodiments, additional software components 400, 415, 435, 440, 445, 450, 455, 460 and/or 470 for performing any of the methods or functions disclosed herein. It should be noted that a software component may be replaced or supplemented by a software module.

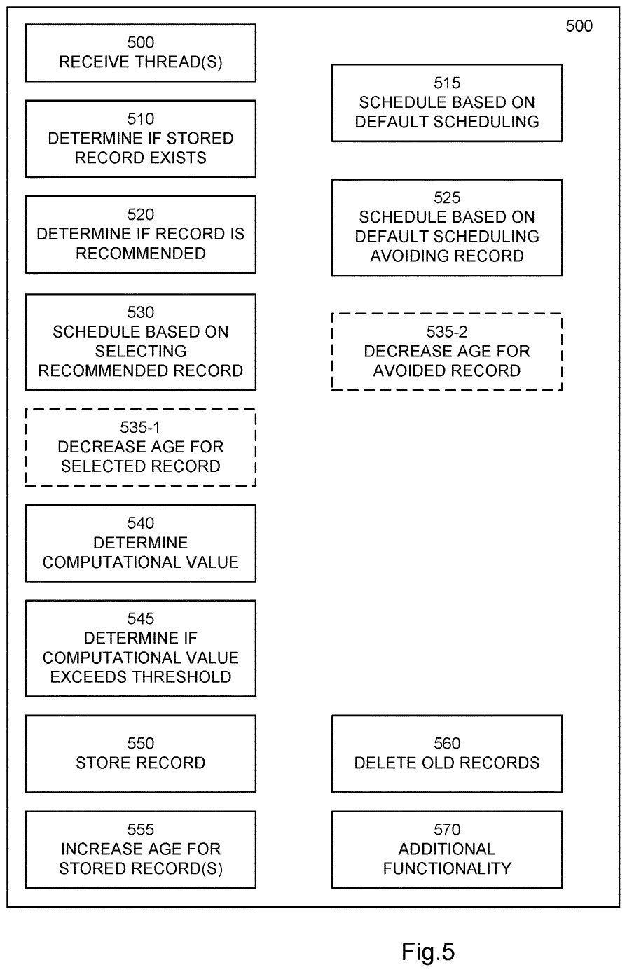

FIG. 5 shows a component view for a scheduler 500 comprising circuitry for scheduling multiple threads in a multi-core system according to an embodiment of the teachings herein. The scheduler 500 comprising circuitry is adapted to be used in a computing arrangement 100 as taught herein, wherein the scheduler 500 of FIG. 5 is arranged for scheduling a computational thread 240 to at least one processing resource 235 of a pool of processing resources 230 for execution in a combination of computational threads 250 comprising the computational thread and a plurality of other computational threads 245, wherein the scheduler 500 comprises: circuitry 510 arranged to determine if there is a stored record 225 representing a scheduling of the combination of computational threads 250 in a record store 220; circuitry 520 arranged to determine if the represented scheduling of the combination of computational threads 250 is a recommended scheduling of the combination of computational threads 250 if there is a stored record; and circuitry 530 arranged to perform the scheduling by selecting the recommended scheduling of the combination of computational threads 250 thereby providing a selected scheduling of the combination of computational threads 250 if the represented scheduling of the combination of computational threads 250 is a recommended scheduling of the combination of computational threads 250, circuitry 525 arranged to perform the scheduling based on the default scheduling algorithm avoiding the represented scheduling of the combination of computational threads 250 thereby providing the selected scheduling of the combination of computational threads 250 different from the represented scheduling of the combination of computational threads 250 if the represented scheduling of the combination of computational threads 250 is not a recommended scheduling of the combination of computational threads 250, wherein each record in the plurality of stored records represents a scheduling of a combination of computational threads and a computational value for the combination of computational threads, wherein the computational value for the combination of computational threads is either above a recommended threshold, whereby the record is a recommended record, or below an avoidance threshold, whereby the record is a record to be avoided.

As is indicated in FIG. 5, the scheduler 500 comprises in some embodiments additional circuitry 500, 515, 535, 540, 545, 550, 555, 560 and/or 570 for performing any of the methods or functions disclosed herein.

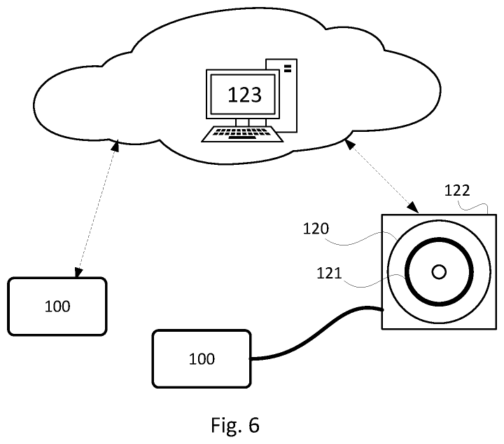

FIG. 6 shows a schematic view of a computer-readable medium 120 carrying computer instructions 121 that when loaded into and executed by a controller of a computing arrangement 100 enables the computing arrangement 100 to implement the present invention.

The computer-readable medium 120 may be tangible such as a hard drive or a flash memory, for example a USB memory stick or a cloud server. Alternatively, the computer-readable medium 120 may be intangible such as a signal carrying the computer instructions enabling the computer instructions to be downloaded through a network connection, such as an internet connection.

In the example of FIG. 6, a computer-readable medium 120 is shown as being a computer disc 120 carrying computer-readable computer instructions 121, being inserted in a computer disc reader 122. The computer disc reader 122 may be part of a cloud server 123—or other server—or the computer disc reader may be connected to a cloud server 123—or other server. The cloud server 123 may be part of the internet or at least connected to the internet. The cloud server 123 may alternatively be connected through a proprietary or dedicated connection. In one example embodiment, the computer instructions are stored at a remote server 123 and be downloaded to the memory 102 of the computing arrangement 100 for being executed by the controller 101.

The computer disc reader 122 may also or alternatively be connected to (or possibly inserted into) a computing arrangement 100 for transferring the computer-readable computer instructions 121 to a controller of the computing arrangement 100 (presumably via a memory of the computing arrangement 100).

FIG. 6 shows both the situation when a computing arrangement 100 receives the computer-readable computer instructions 121 via a wireless server connection (non-tangible) and the situation when another computing arrangement 100 receives the computer-readable computer instructions 121 through a wired interface (tangible). This enables for computer-readable computer instructions 121 being downloaded into a computing arrangement 100 thereby enabling the computing arrangement 100 to operate according to and implement the invention as disclosed herein.

1-18. (canceled)

19. A method for scheduling a computational thread to at least one processing resource of a pool of processing resources for execution in a combination of computational threads comprising the computational thread and a plurality of other computational threads, the method being performed by a scheduler, the method comprising:
determining if there is a stored record representing a scheduling of the combination of computational threads in a record store;
if there is a stored record, determine if the represented scheduling of the combination of computational threads is a recommended scheduling of the combination of computational threads; and
if the represented scheduling of the combination of computational threads is a recommended scheduling of the combination of computational threads, then perform the scheduling by selecting the recommended scheduling of the combination of computational threads thereby providing a selected scheduling of the combination of computational threads, and
if the represented scheduling of the combination of computational threads is not a recommended scheduling of the combination of computational threads, then perform the scheduling based on the default scheduling algorithm avoiding the represented scheduling of the combination of computational threads thereby providing the selected scheduling of the combination of computational threads different from the represented scheduling of the combination of computational threads,
wherein each record in the plurality of stored records represents a scheduling of a combination of computational threads and a computational value for the combination of computational threads, wherein the computational value for the combination of computational threads is either above a recommended threshold, whereby the record is a recommended record, or below an avoidance threshold, whereby the record is a record to be avoided.

20. The method according to claim 19, wherein the method further comprises if there is no stored record, performing the scheduling based on a default scheduling algorithm providing the selected scheduling of the combination of computational threads.

21. The method according to claim 19, wherein the recommended scheduling indicates the at least one processing resource to be used for scheduling.

22. The method according to claim 19, wherein the recommended scheduling is the represented scheduling with a highest computational value.

23. The method according to claim 19, wherein the method further comprises marking the represented scheduling with a highest computational value as unavailable during the execution of the scheduled computational thread, whereby the represented scheduling with a second highest computational value is regarded as the represented scheduling with the highest computational value.

24. The method according to claim 19, wherein the recommended threshold is determined based on a distance to the average of computational values and is greater than the average of computational values, and wherein the avoiding threshold is determined based on a distance to the average of computational values and is lower than the average of computational values.

25. The method according to claim 19, wherein the method further comprises updating the record store by:
determining a computational value for the selected scheduling;
determining if the computational value for the selected scheduling is above the recommended threshold or below the avoidance threshold, and if so storing a record for the selected scheduling.

26. The method according to claim 25, wherein storing a record for the selected scheduling comprises determining if there is a stored record for the selected scheduling and if so, updating the stored record with the determined computational value.

27. The method according to claim 25, wherein updating the record store further comprises determining if the record store is full prior to determining if the computational value for the selected scheduling is above the recommended threshold or below the avoidance threshold, and if the record store is not full, storing the record for the selected scheduling.

28. The method according to claim 27, wherein the method further comprises determining an average of computational values prior to determining if the computational value for the selected scheduling is above the recommended threshold or below the avoidance threshold.

29. The method according to claim 25, wherein updating the record store further comprises increasing the age of the records in the record store, wherein the age of avoided record(s) and selected record(s) are not increased.

30. The method according to claim 29, wherein the age of avoided record(s) and selected record(s) are not increased by setting the age of the record to zero.

31. A method of updating a record store comprising a plurality of records, each record in the plurality of stored records indicating a combination of computational threads and a computational value for the combination of computational threads, wherein the computational value for the combination of computational threads is either above a recommended threshold, whereby the record is a recommended record, or below an avoidance threshold, whereby the record is a record to be avoided, and wherein the method comprises:
determining a computational value for a selected scheduling; and
determining if the computational value for the selected scheduling is above the recommended threshold or below the avoidance threshold, and if so storing a record for the selected scheduling.

32. The method of claim 31, wherein the method further includes updating the record store by deleting records whose age is below an age threshold.

33. A computing arrangement configured to schedule a computational thread to at least one processing resource of a pool of processing resources for execution in a combination of computational threads comprising the computational thread and a plurality of other computational threads, the computing arrangement comprising processing circuitry configured to:
determine if there is a stored record representing a scheduling of the combination of computational threads in a record store;
if there is a stored record, determine if the represented scheduling is a recommended scheduling; and
if the represented scheduling is a recommended scheduling, then perform the scheduling by selecting the recommended scheduling, and
if the represented scheduling is not a recommended scheduling, then perform the scheduling based on the default scheduling algorithm avoiding the represented scheduling providing a selected scheduling different from the represented scheduling;
wherein each record in the plurality of stored records indicates a represented scheduling of a combination of computational threads and a computational value for the combination of computational threads, wherein the computational value for the combination of computational threads is either above a recommended threshold, whereby the record is a recommended record, or below an avoidance threshold, whereby the record is a record to be avoided.

34. A scheduler comprising circuitry for scheduling a computational thread to at least one processing resource of a pool of processing resources for execution in a combination of computational threads comprising the computational thread and a plurality of other computational threads, wherein the scheduler comprises:
circuitry configured to determine if there is a stored record representing a scheduling of the combination of computational threads in a record store;
circuitry configured to determine if the represented scheduling of the combination of computational threads is a recommended scheduling of the combination of computational threads if there is a stored record; and
circuitry configured to perform the scheduling by selecting the recommended scheduling of the combination of computational threads thereby providing a selected scheduling of the combination of computational threads if the represented scheduling of the combination of computational threads is a recommended scheduling of the combination of computational threads; and
circuitry configured to perform the scheduling based on the default scheduling algorithm avoiding the represented scheduling of the combination of computational threads thereby providing the selected scheduling of the combination of computational threads different from the represented scheduling of the combination of computational threads if the represented scheduling of the combination of computational threads is not a recommended scheduling of the combination of computational threads;
wherein each record in the plurality of stored records represents a scheduling of a combination of computational threads and a computational value for the combination of computational threads, wherein the computational value for the combination of computational threads is either above a recommended threshold, whereby the record is a recommended record, or below an avoidance threshold, whereby the record is a record to be avoided.
